(19) United States
(12) Patent Application Publication
(10) Pub. No.: US 2013/0133503 A1
(43) Pub. Date: May 30, 2013

(54) Plectra with Wear Indicator and Related Methods

(71) Applicant: Phillip Jason Everly, North Hollywood, CA (US)

(72) Inventor: Phillip Jason Everly, North Hollywood, CA (US)

(21) Appl. No.: 13/304,644

(22) Filed: Nov. 26, 2011

(51) Int. Cl. G10D 3/16

(52) U.S. Cl. 84/322

(57) ABSTRACT

A pick that may have: a first layer or core that is configured with a first color; a second layer or coating configured with a second color; and, wherein said second color visually contrasts with the first color. Operably, the coating or second layer may be abraded whenever the pick is used to flick a guitar string whereby the coating or second layer erodes to expose the first color of the core or first layer. A musician may identify that the pick is worn out via seeing the first color showing through from underneath the coating or second layers.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

This invention relates to plectrum for strumming or picking strings of a stringed musical instrument. More particularly this invention relates to plectrum with wear-indication means. Specifically, the invention relates to a pick that changes color when worn-out so that a musician may identify whether the pick is suitable for use.

2. Background

Plectrum, colloquially “picks,” are typically small and flat hand held tools used by musicians to aid in the strumming or plucking of the strings of a stringed musical instrument. Frequently, picks are formed in the shape of a triangle, tear drop, or other pointed structure. Operably, the point of the pick is positioned against a string and flicked so that the string vibrates to produce sound. While metal picks are known, picks are typically made of plastic. The edges of plastic picks dull or wear down with use.

For most musicians, sharp edges on a pick are preferable to dull edges. It is thought that a dull pick edge used to pluck a string of a musical instrument does not result in the highest possible sound quality. During a sound producing flick of a string, contact between a sharp edged pick and the string ends abruptly at the edge so that the string is immediately free to vibrate. For contrast, a string slides over the edge of a dulled pick so that contact between the pick and string does not end so abruptly. To wit, the lower quality sound produced by a dulled pick may be due to continued contact with the over the dulled edge. Accordingly, there is a need for means to readily differentiate usable picks from worn-out or dulled picks.

One solution to the above identified need is a pick disclosed in U.S. Pat. No. 6,008,442 (issued Dec. 28, 1998). The disclosed pick features a reference line on its surface so that a musician may visually determine whether a pick is worn out via comparing the distance between the pick edge and reference line since the edge of a pick erodes away with use. Practically, whenever a musician that is using a disclosed pick sees that the edge of that pick has eroded to alignment with the reference line, the pick is worn-out and may be replaced.

Although one suitable means for identifying worn-out picks, U.S. Pat. No. 6,008,442 is not entirely satisfactory for identifying worn out picks. Importantly, a musician using a pick with a reference line must cognitively assess and evaluate the distance between the reference line and the edge to determine whether the pick is worn-out. Such a mental exercise is distracting and may result in lost focus. The distraction and lost focus can be particularly unsatisfactory when a pick becomes worn out and in need of being replaced during a live musical performance requiring the musician's full attention. Accordingly, there remains a need for means to readily differentiate usable picks from worn-out or dulled picks.

### SUMMARY OF THE INVENTION

The objective of this specification is to disclose a pick with means for readily identifying whether the pick is usable or worn-out and in need of replacement. In a non-limiting embodiment, what is disclosed may be a pick comprising: a first layer or core that is configured with a first color; a second layer or coating configured with a second color; and, wherein said second color visually contrasts with the first color. Operably, the coating or second layer may be abraded whenever the pick is used to flick a guitar string whereby the coating erodes to expose the first color. A musician may identify that the pick is worn out via seeing the first color through the second color. In this way, a live performance musician may identify a worn out pick via observation of colors rather than via assessing distances between the pick edge and a reference line.

### BRIEF DESCRIPTION OF THE FIGURES

Other objectives of the disclosure will become apparent to those skilled in the art once the invention has been shown and described. The manner in which these objectives and other desirable characteristics can be obtained is explained in the following description and attached figures in which:

FIG. 1A is a plan view of a guitar pick 100;

FIG. 1B is a perspective view of the tip 110 of the guitar pick 100 of FIG. 1A.

FIG. 2A is a plan view of a lightly used guitar pick 100;

FIG. 2B is a perspective view of the tip 110 of the guitar pick 100 of FIG. 2A;

FIG. 3A is a plan view of a heavily used guitar pick 100;

FIG. 3B is a perspective view of the tip 110 of the guitar pick 100 of FIG. 3A;

FIG. 4A is a plan view of a worn-out guitar pick; and,

FIG. 4B is a perspective view of the tip 110 of the guitar pick 100 of FIG. 4A.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a pick with means for readily identifying whether the pick is usable or worn-out and in need of replacement. Generally, the disclosed pick may have: a first layer or core that is configured with a first color; a second layer or coating configured with a second color; and, wherein said second color visually contrasts with the first color. Operably, the coating or second layer may be abraded whenever the pick is used to flick a guitar string whereby the coating or second layer erodes to expose the first color of the core or first layer. A musician may identify that the pick is worn out via seeing the first color showing through from underneath the coating or second layers. In this way, a live performance musician may identify a worn out pick via observation of the first color. The more specific details of the pick are disclosed with reference to the drawings.

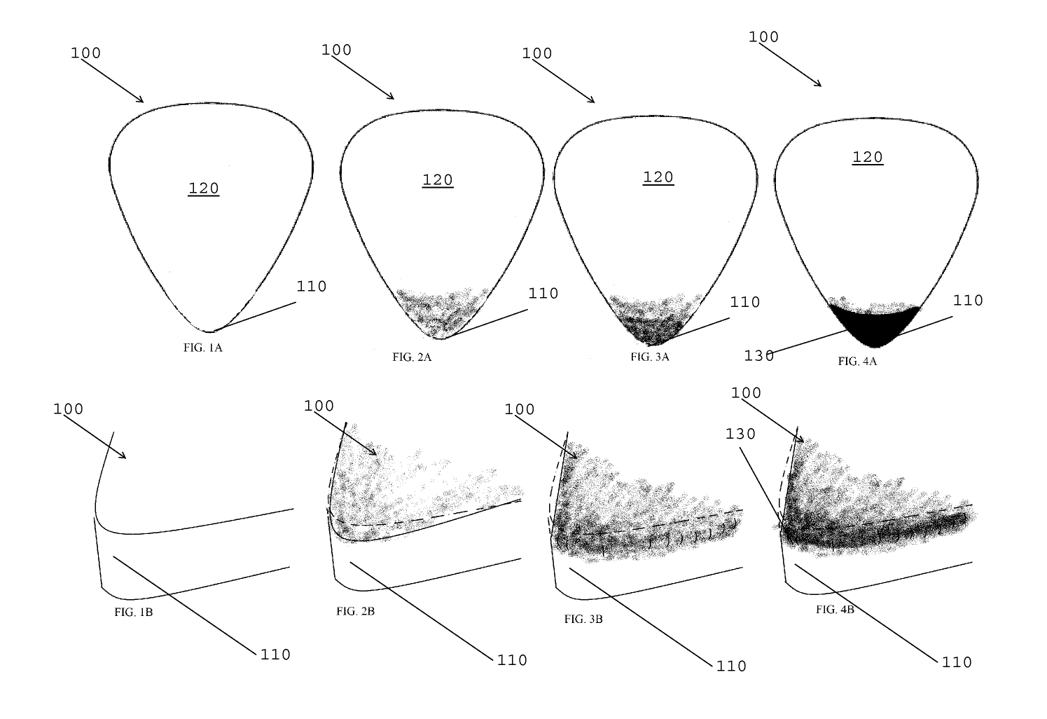

FIG. 1A is a plan view of an unused guitar pick 100 and FIG. 1B is a perspective view of the tip 110 of the guitar pick 100 of FIG. 1A. FIG. 2A is a plan view of a lightly used guitar pick 100 and FIG. 2B is a perspective view of the tip 110 of the guitar pick 100 of FIG. 2A. FIG. 3A. FIG. 4A is a plan view of a worn-out guitar pick FIG. 4B is a perspective view of the tip 110 of the guitar pick 100 of FIG. 4A. FIG. 3A is a plan view of a heavily used guitar pick 100 and FIG. 3B is a perspective view of the tip 110 of the guitar pick 100 of FIG. 3A. Structurally, the depicted pick is: generally triangular with a point 110; composed of a core 120 and a coating 130. Operably, the pick 100 is configured for flicking the strings of a stringed musical instrument at its tip 110.

Referring the figures, the coating 130 is white and preferably constructed of plastic that has been molded around a black plastic core 120. Progressing sequentially through the figures beginning with FIG. 1A, the coating 120 may preferably and gradually abrade whenever the pick 100 is flicked against a guitar string. Ultimately, the coating 130 thins via continued use until the core 130 is exposed through the coating 120. The original service of the pick 100 shown in FIGS. 2B, 3B, and 4B is depicted by broken lines to illustrate erosion or abrasion of the coating 130. It should be noted that: although the pick 100 is depicted as a core 130 with a coating 120, the pick 100 may be constructed of two layers wherein one of the layers may be abraded away in the same manner disclosed above in connection with the coating; and, although the drawings depict a black core and white coating, any two different colors could be used without departing from the spirit and intent of this specification.

The pick 100 may preferably be constructed of plastic or other suitable material by molding or cutting. Suitably, the pick may be constructed of thin and rigid plastics such as polycarbonate, nylon, or vinyl although other materials may be used without departing from the spirit of this disclosure. The core and coating may be constructed of the same or different materials of different color. For example, a pick of a single material may be dyed a different color on one surface so that its color is changed for a fraction of the way through the pick. For another example, the coating may be ink that is printed on or otherwise applied to a plastic or metal pick. In another example the pick is two layers of different colored plastic that are glued or otherwise adhered together. Other embodiments may conform structurally to those disclosed or referenced in U.S. Pat. No. 6,008,442 (issued Dec. 28, 1998).

This specification and the appended figures illustrate only typical embodiments or principles disclosed in this application, and therefore, are not to be considered limiting of its scope, for the invention may admit to other equally effective embodiments that will be appreciated by those reasonably skilled in the relevant arts. Any invention disclosed by this specification is defined by the claims.

I claim:

1. A plectra comprising of:
a core having a first color; and,
a coating on at least a portion of the core having a second color.

2. The plectra of claim 1 wherein the first and second colors contrast.

3. The plectra of claim 1 wherein the coating is configured to abrade when contacting a string.

4. The plectra of claim 1 wherein the coating is plastic;

5. The plectra of claim 1 wherein the core is plastic.

6. A plectra comprising
a first layer having a first color; and,
a second layer having a second color.

7. The plectra of claim 6 wherein the first and second colors contrast.

8. The plectra of claim 6 wherein the coating is configured to abrade when contacting a string.

9. The plectra of claim 6 wherein the coating is plastic;

10. The plectra of claim 6 wherein the core is plastic.

11. A method of using a guitar pick comprising the steps of:
obtaining a pick with a core that has a coating on at least a portion of its surface to hide the core's color;
flicking a string with the pick so that the coating abrades;
identifying the core's color through the abraded coating; and, discarding the pick.

12. The method of claim 11 wherein the color of the core contrasts with a color of the coating.

13. The method of claim 11 wherein the coating is configured to abrade when contacting the string.

14. The method of claim 11 wherein the core is a first layer and the coating is a second layer of the pick.

15. The method of claim 14 wherein the layers are molded together

16. The method of claim 11 wherein the coating is molded around the core.

17. The method of claim 11 wherein the coating is plastic;

18. The method of claim 15 wherein the coating is vinyl.

19. The method of claim 11 wherein the core is plastic.

20. The method of claim 17 wherein the core is vinyl.
